(19) United States
(12) Patent Application Publication
(10) Pub. No.: US 2024/0359957 A1
(43) Pub. Date: Oct. 31, 2024

(54) NESTING LIFT ARM WITH INTEGRATED STOPS

(71) Applicant: Vehicle Service Group, LLC, Madison, IN (US)

(72) Inventors: Bryan Taylor, Madison, IN (US); John Uhl, Madison, IN (US); Jason Matthews, Madison, IN (US); Ron Schneider, Madison, IN (US)

(73) Assignee: Vehicle Service Group, LLC, Madison, IN (US)

(21) Appl. No.: 18/648,329

(22) Filed: Apr. 26, 2024

Related U.S. Application Data
(60) Provisional application No. 63/462,752, filed on Apr. 28, 2023.

(51) Int. Cl. B66F 7/28

(52) U.S. Cl. CPC B66F 7/28

(57) ABSTRACT

A vehicle engagement assembly is attached to a vehicle lift, wherein the vehicle lift is configured to actuate the engagement assembly between lowered and raised positions, and the vehicle engagement assembly includes: a first arm including a first notch, a second arm including a second notch, an adapter coupling arm including a coupling portion, and an adapter that couples with the coupling portion. The second arm can transition between a first extended configuration and a first retracted configuration relative to the first arm. The adapter fits within the first notch when both the second arm is in the first retracted configuration and the adapter coupling arm is in the second retracted configuration. The adapter coupling arm is configured to transition between a second extended configuration and a second retracted configuration relative to the second arm.

### PRIORITY STATEMENT

This application claims priority of U.S. Provisional Patent Application No. 63/462,752, entitled “Nesting Lift Arm with Integrated Stops,” filed Apr. 28, 2023.

### BACKGROUND

A vehicle lift is a device operable to lift a vehicle such as a car, truck, bus, locomotive, etc. Vehicle lifts have varying designs and capabilities, including platform lifts that lift a parked vehicle via contact with tires in order to allow access to the underside of the vehicle; as well as frame-engaging lifts that raise a vehicle by contacting structural lifting points on the frame or other contact points of the vehicle, allowing access to the underside of the vehicle and allowing wheels and tires to be removed or serviced.

Since vehicle service often includes removing or inspecting tires and wheels, frame-engaging, suspension-engaging, or other underside-engaging lifts are a popular option. Vehicle lifts may include adjustable arms configured to adjust into various positions to suitably engage the underside of a vehicle. In some instances, an adjustable arm may be able to adjust its own length to suitably engage the underside of a vehicle. Additionally, or alternatively, an adjustable arm may be configured to pivot relative to other portions of the vehicle lift to suitably engage the underside of a vehicle.

While a variety of vehicle lifts have been made and used, it is believed that no one prior to the inventor(s) has made or used an invention as described herein.

### BRIEF DESCRIPTION OF THE DRAWINGS

While the specification may conclude with claims which particularly point out and distinctly claim the invention, it is believed the present invention will be better understood from the following description of certain examples taken in conjunction with the accompanying drawings, in which like reference numerals identify the same elements and in which:

FIG. 1A is a perspective view of an illustrative two-post lift assembly in a lowered configuration;

FIG. 1B is a perspective view of the two-post lift assembly of FIG. 1A in a raised configuration;

FIG. 2 is an exploded perspective view of an illustrative adjustable lift arm that may be readily incorporated into the two-post lift assembly of FIG. 1A;

FIG. 3A is a top perspective view of an adapter coupling arm of the adjustable lift arm of FIG. 2;

FIG. 3B is a bottom perspective view of the adapter coupling arm of FIG. 3A;

FIG. 3C is a perspective view of an adapter coupling end of the adapter coupling arm of FIG. 3A;

FIG. 4 is a perspective view of an adapter of the adjustable lift arm of FIG. 2;

FIG. 5A is a top perspective view of an adjustable body of the adjustable lift arm of FIG. 2;

FIG. 5B is a bottom perspective view of the adjustable body of FIG. 5A;

FIG. 6 is a perspective view of a collar of the adjustable lift arm of FIG. 2;

FIG. 7A is a cross-sectional view of the adjustable lift arm of FIG. 2, with the adjustable body and adapter coupling arm each in an extended configuration;

FIG. 7B is a cross-sectional view of the adjustable lift arm of FIG. 2, with the adjustable body in the extended configuration and the adapter coupling arm in a retracted configuration;

FIG. 7C is a cross-sectional view of the adjustable lift arm of FIG. 2, with the adjustable body and adapter coupling arm each in a retracted configuration;

FIG. 8A is a perspective view of the adjustable lift arm of FIG. 2, with the adjustable body and adapter coupling arm each in an extended configuration, with the adapter of FIG. 4 in a lowered configuration;

FIG. 8B is a perspective view of the adjustable lift arm of FIG. 2, with the adjustable body in the extended configuration and the adapter coupling arm in a retracted configuration, with the adapter of FIG. 4 in the lowered configuration;

FIG. 8C is a perspective view of the adjustable lift arm of FIG. 2, with the adjustable body in the extended configuration and the adapter coupling arm in a retracted configuration, with the adapter of FIG. 4 in a raised configuration;

FIG. 8D is a perspective view of the adjustable lift arm of FIG. 2, with the adjustable body and the adapter coupling arm both in a retracted configuration, with the adapter of FIG. 4 in the raised configuration;

FIG. 9 is an elevation side view of the adapter coupling arm of FIG. 3A and the adapter of FIG. 4, with the adapter in the lowered configuration;

FIG. 10 is a cross-sectional view of an alternative adjustable body that may be readily incorporated into the adjustable lift arm of FIG. 2;

FIG. 11 is a cross-sectional view of an alternative collar that may be readily incorporated into the adjustable lift arm of FIG. 2;

FIG. 12 is a top perspective view of an alternative adapter coupling arm of the adjustable lift arm of FIG. 2;

FIG. 13 is an exploded perspective view of the adapter coupling arm of FIG. 12;

FIG. 14 is a cross-sectional view of the adapter coupling arm of FIG. 12 and the adapter of FIG. 2;

FIG. 15 is a perspective view of the adapter coupling arm of FIG. 12 and the adapter of FIG. 2, with the adapter in a distal position; and

FIG. 16 is a perspective view of the adapter coupling arm of FIG. 12 and the adapter of FIG. 2, with the adapter in a proximal position.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the resent invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is, by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

While the illustrative examples herein describe a frame-engaging lift, it would be obvious to one of ordinary skill in the art that the same invention could be applied to a lift which engages the suspension, or any other lift point designated by the manufacturer. These designated lift points are typically located on the underside of the vehicle, but may be any point engineered to withstand the weight of the vehicle.

### I. Overview of Illustrative Frame-Engaging Lift

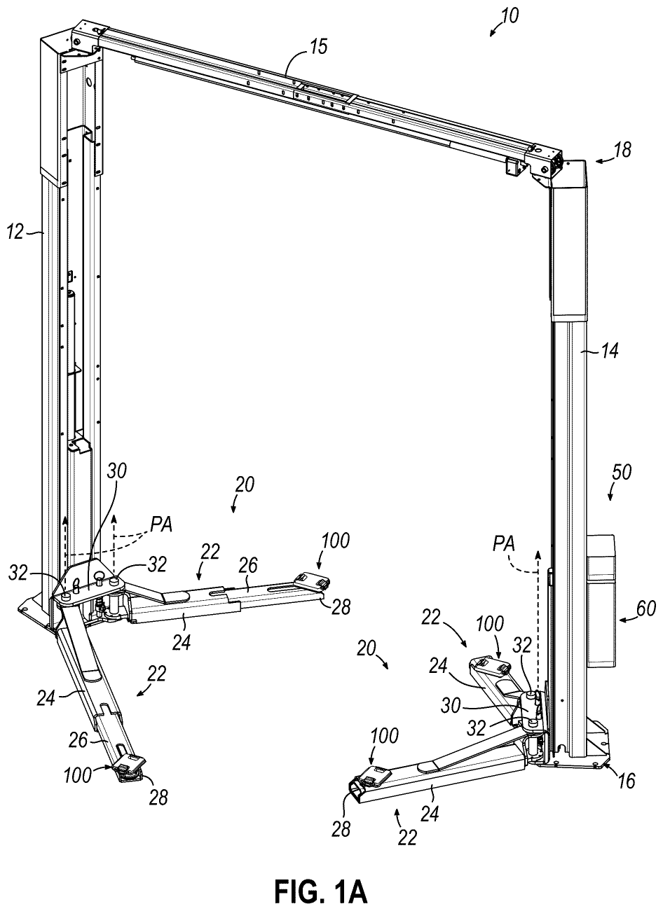

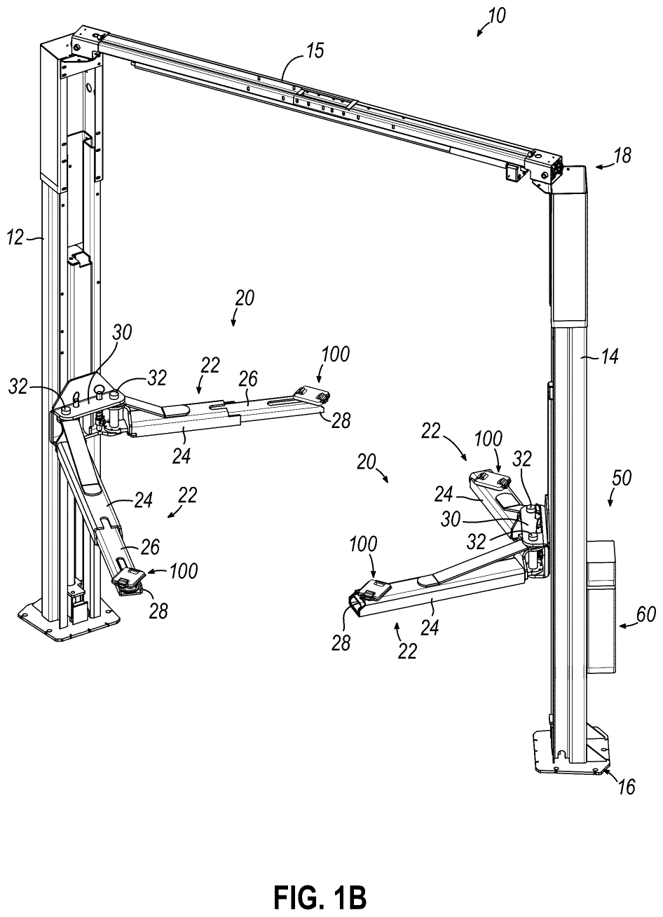

FIGS. 1A-1B show an illustrative frame-engaging vehicle lift, a two-post lift (10), that can be used to raise a vehicle, allow access to the underside of the vehicle, and allow wheels and tires of the vehicle to be removed or serviced. While the current frame-engaging vehicle lift is a two-post lift (10), any other suitable frame-engaging vehicle lift may be used as would be apparent to one skilled in the art in view of the teachings herein. For example, the frame-engaging vehicle lift may be a scissor-lift assembly, a four-post lift, an in-ground lift such as Smartlift® manufactured and sold by Vehicle Service Group, LLC, or one or more portable lifts, etc.

Two-post lift (10) includes a pair of lift posts (12, 14), a crossbar (15) extending between lift posts (12, 14), a pair of lifting carriages (20) operatively coupled to a respective lift post (12, 14), a control assembly (50), and a drive assembly (60). Lift posts (12, 14) extend from a floor (16) to an elevated portion (18), while a crossbar (15) extends between lift posts (12, 14) at elevated portion (18). Crossbar (15), while entirely optional, may provide at least some degree of structural stability between lift posts (12, 14).

Lifting carriages (20) are configured to synchronously actuate along a path defined by respective lift posts (12, 14) between a lowered position (as shown in FIG. 1A) and a raised position (as shown in FIG. 1B). Lifting carriages (20) may also selectively lock into place relative to respective lift posts (12, 14) such that lifting carriages (20) may be prevented from inadvertently lowering once reaching a desired height. Therefore, lift posts (12, 14) may provide a mechanical path for respective lifting carriages (20) to actuate along. Any suitable components to promote synchronous actuation and locking of lifting carriages (20) relative to lift posts (12, 14) may be used as would be apparent to one skilled in the art in view of the teachings herein. As will be described in greater detail below, lifting carriages (20) are configured to engage the frame of a vehicle such that as lifting carriages (20) actuate between the lowered position (as shown in FIG. 1A) and the raised position (as shown in FIG. 1B), the vehicle will also be lifted and lowered between corresponding lowered and raised positions.

Each lifting carriage (20) includes a base frame (30) and a pair of adjustable lifting arms (22) configured to be adjusted relative to their respective base frame (30) and relative to each other in order to suitably engage a vehicle frame. Base frames (30) suitably engage their respective lift post (12, 14) such that lifting carriages (20) may synchronously actuate along their path defined by lift posts (12, 14).

Each lifting arm (22) includes a collar (24) and an adjustable body (26) that terminates in an adapter coupling end (28). Each collar (24) is pivotally coupled to base frame (30) of the respective carriage (20) about a pivot axis (PA) via a pivot pin (32). Therefore, collar (24), adjustable body (26), and adapter coupling end (28) may be pivoted about pivot axis (PA) together into various rotational positions relative to base frame (30). In some instances, carriages (20) may have a pivot restraint mechanism to selectively fix each collar (24) into a desired rotational position relative to base frame (30) about pivot axis (PA). Therefore, lifting arms (22) may be pivoted and restrained into a desired rotational position relative to base frame (30) of carriage (20) in order to suitably align with specific vehicle lift points.

Adjustable body (26) may actuate along a linear path defined by a respective collar (24) and into various longitudinal positions relative to collar (24). In some instances, carriages (20) may have a linear locking mechanism to selectively fix the longitudinal position of adjustable body (26) relative to the respective collar (24). Therefore, adjustable body (26) may be actuated and locked into a desired longitudinal position relative to the respective collar (24) in order to suitably align with specific vehicle lift points.

Adjustable body (26) and adapter coupling end (28) may be fixed relative to each other, although this is merely optional. Adapter coupling end (28) is configured to selectively couple with various arm adapters, such as arm adapter (100). Arm adapters (100) may be configured to suitably engage vehicle frames such that lifting carriages (20) may lift vehicles in accordance with the description herein.

Two-post lift (10) may be connected to a power supply (not pictured) to provide power to various components of two-post lift (10), such as control assembly (50) and drive assembly (60). Control assembly (50) is operatively connected to drive assembly (60) such that an operator may utilize control assembly (50) to selectively activate drive assembly (60) in accordance with the teachings herein. Control assembly (50) may include any suitable components, such as a processor, logic control, etc., as would be apparent to one skilled in the art in view of the teachings herein. Additionally, control assembly (50) may include any suitable number of user input features in order to utilize two-post lift (10) in accordance with the description herein. In the current example, control assembly (50) is physically attached to the rest of two-post lift (10), but this is merely optional. In some embodiments, control assembly (50) may be detached from the rest of two-post lift (10) such that control assembly (50) is in wired/wireless communication with other suitable components of two-post lift (10). In some embodiments, control assembly (50) is incorporated into a fixed control panel, a wired or wireless pendant, a smart phone, a tablet, or a control station such as a desktop or laptop.

Drive assembly (60) is configured to raise and lower carriages (20) in accordance with the description herein by producing mechanical energy that is translated to a lifting motion of the carriages (20) through a mechanical linkage, hydraulic system, screw mechanism, other systems, or any combination thereof as will be apparent to one skilled in the art in view of the teachings herein. Therefore, drive assembly (60) may include any number of suitable components to raise and lower carriages (20) in accordance with the description herein.

During illustrative use, the operator may place a vehicle between lift posts (12, 14) with carriages (20) at or near the lowered position. Next, the operator may suitably align carriages (20) with a frame of the vehicle by rotating and extending/retracting adjustable lift arms (22). When carriages (20) have been suitably positioned such that arm adapters (100) are aligned with the frame of the vehicle, the operator may utilize control assembly (50) in order to activate drive assembly (60) to synchronously raise carriages (20) such that arm adapters (100) engage the frame and thereby lift the vehicle. Once carriages (20) lift the vehicle to a desired height, the operator may utilize control assembly (50) to instruct drive assembly (60) to stop raising carriages (20). In some instances, a vertical lockout assembly may be used to ensure carriages (20) remain locked at the desired height along lift posts (12, 14).

When the operator desires to lower the vehicle, the operator may use control assembly (50) to activate drive assembly (60) to synchronously lower carriages (20) such the vehicle is lowered to the ground and arm adapters (100) disengage the frame of the vehicle. With arm adapters (100) disengaged from the frame of the vehicle, the vehicle may be removed from the lifting area, and another vehicle may be subsequently moved into the lifting area for service.

II. Illustrative Adjustable Lift Arms with Nesting Features and Integrated Interior Stops

As mentioned above, adjustable lift arms (22) may actuate to either extend or retract adapter (100) relative to pivot pin (32). In the previous example, actuation between collar (24) and adjustable body (26) allows adapter (100) to transition between a fully extended configuration (when adapter (100) is the furthest away from pivot pin (32)) and a fully retracted configuration (when adapter (100) is the closest to pivot pin (32)). Adjustable body (26) and collar (24) have a telescoping relationship, which allows adjustable body (26) to extend and retract relative to collar (24). Adjustable lift arms (22) may include more than one telescoping member to further increase the fully extended range by offering a multi-stage extension (e.g., a three-stage extension). In order to provide for easier movement between telescoping features of adjustable lift arm (22), it may be desirable to reduce the material used to form lift arm (22). Such reduction of material, in turn, reduces the weight of telescoping features, reducing the frictional braking force that must be overcome to adjust such telescoping features, which may provide easier movement of telescoping features by a technician.

In some instances, whether using a two- or three-stage extension, it may be desirable to lower adapter (100) as close to floor (16) as possible (i.e., a low-profile configuration) in order to accommodate low clearance vehicles. For example, electric vehicles (EVs) may require adapter (100) to reach a low-profile configuration in order to suitably access the underside of such an EV. Further, it may be desirable to inhibit telescoping features of lift arm (22) (e.g., adjustable body (26)) from extending past the extended configuration while still providing for a lower profile configuration. Additionally, in some instances, it may be desirable to have adjustable lift arms (22) that are capable of retracting further into collar (24) while adapter (100) is still suitably attached in order provide for shorter lengths of adjustable lift arm (22) in the retracted configuration.

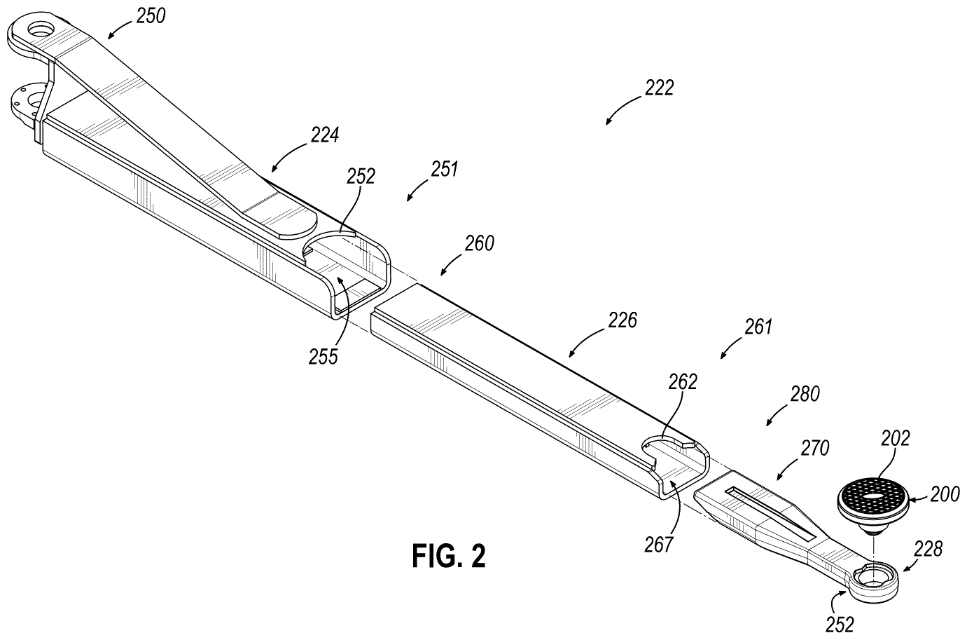

FIGS. 2 and 7A-8D show an adjustable lifting arm (222) that may be substantially similar to adjustable lifting arm (22) described above, with differences elaborated below. Therefore, adjustable lifting arm (222) may be readily incorporated into two-post lift (10) to replace adjustable lifting arm (22) described above. As will be described in greater detail below, adjustable lifting arm (222) may be formed with a reduced amount of material compared to previous lifting arms, which may provide for easier movement of adjustable lifting arm (222) in accordance with the description herein. Additionally, as will be described in greater detail below, lifting arm (222) includes various features that allow for adjustable low-profile configurations while also (A) inhibiting telescoping features from extending past a predetermined extended configuration, and (B) allowing for a shorter fully retracted, yet operational, length.

Adjustable lifting arm (222) includes a collar (224), an adjustable body (226), an adapter coupling arm (270), and an adapter (200). Collar (224) includes a proximal portion (250) and a distal portion (251). Similarly, adjustable body (226) includes its own proximal portion (260) and distal portion (261), while adapter coupling arm (270) also includes its own proximal portion (280) and distal portion (282). Collar (224), adjustable body (226), and adapter coupling arm (270) are slidably coupled together in a telescoping relationship. In particular, adjustable body (226) is slidably contained within a telescoping channel (255) defined by collar (224), while adapter coupling arm (270) is slidably contained within a telescoping channel (267) defined by adjustable body (226).

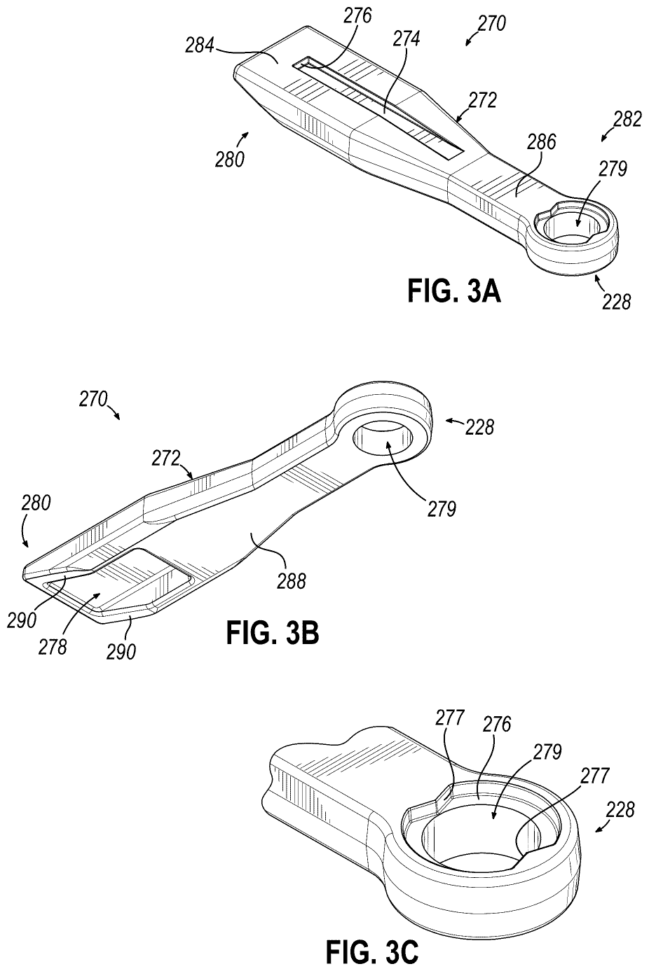

FIG. 3A illustrates a top perspective view of adapter coupling arm (270). Adapter coupling arm (270) includes an adapter coupling end (228) located at distal portion (282), a proximal top surface (284), a distal top surface (286), a lower surface (288) (see FIG. 3B), and a tapered body (272) extending between and attached to top surfaces (284, 286). Adapter coupling arm (270) defines a longitudinally extending groove (274) that terminates proximally in a groove end (276). In particular, a portion of tapered body (272) and proximal top surface (284) together define longitudinally extending groove (274).

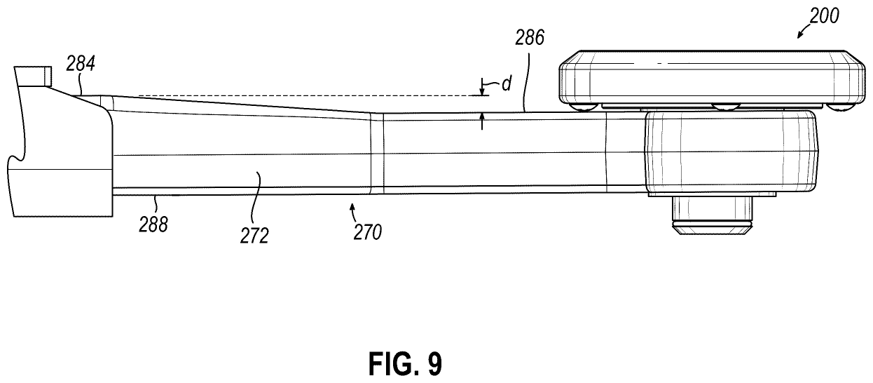

Tapered body (272) reduces in cross-sectional area toward adapter coupling end (228). Reducing cross-sectional area may reduce both weight and cost of adapter coupling arm (270). Tapered body (272) may also provide for better maneuverability (e.g., due to the reduction of weight) while positioning adjustable lifting arm (222) under a lift spot of a vehicle. Additionally, as will be described in greater detail below, tapered body (272) provides a vertical offset distance (d) (see FIG. 9) between top surfaces (284, 286), which may reduce the vertical profile of adapter (200), thereby providing a low-profile configuration, during exemplary use in accordance with the description herein. Adapter coupling end (228) is flared out or bulbous relative to a narrow portion of tapered body (272) such that an operator may easily grab adapter coupling end (228) when extending adjustable lifting arm (222).

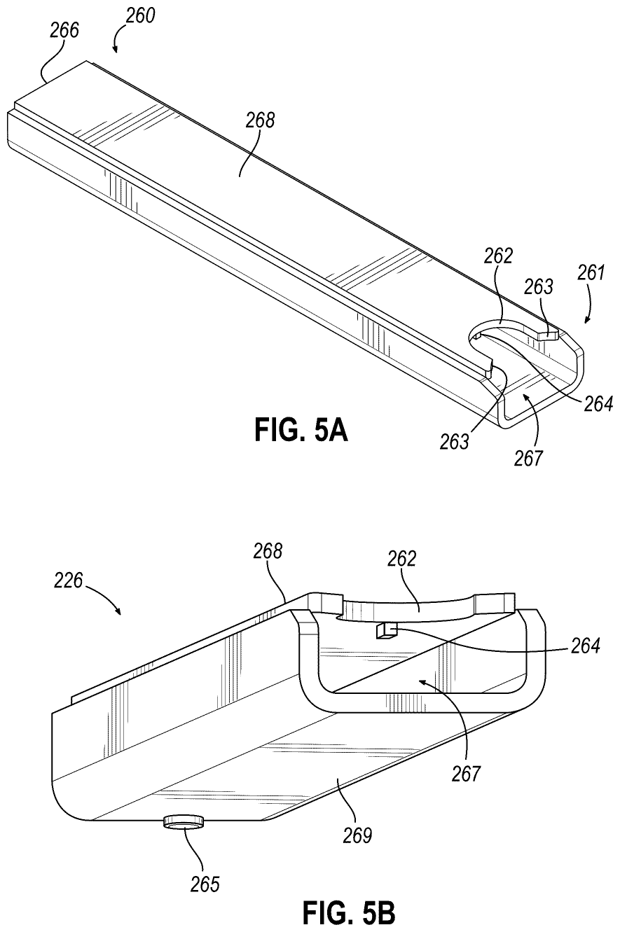

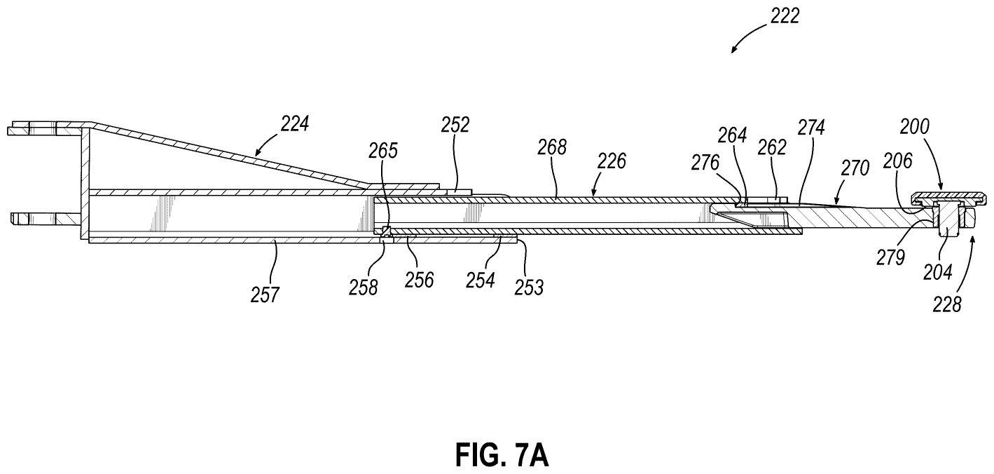

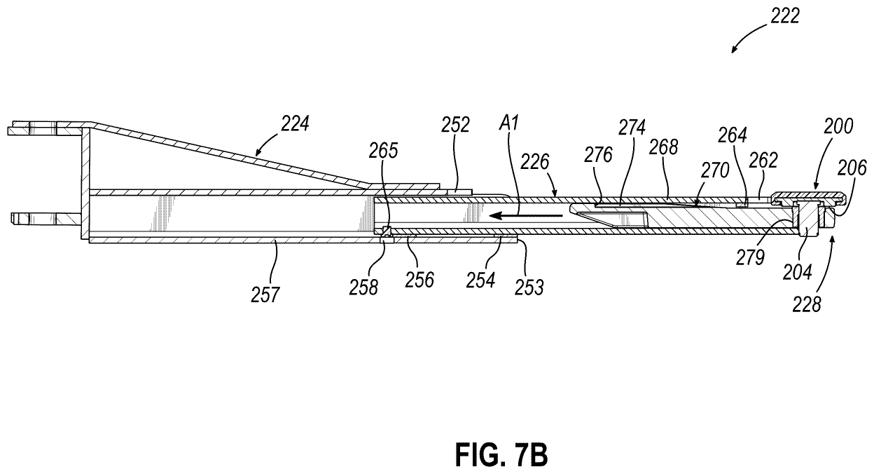

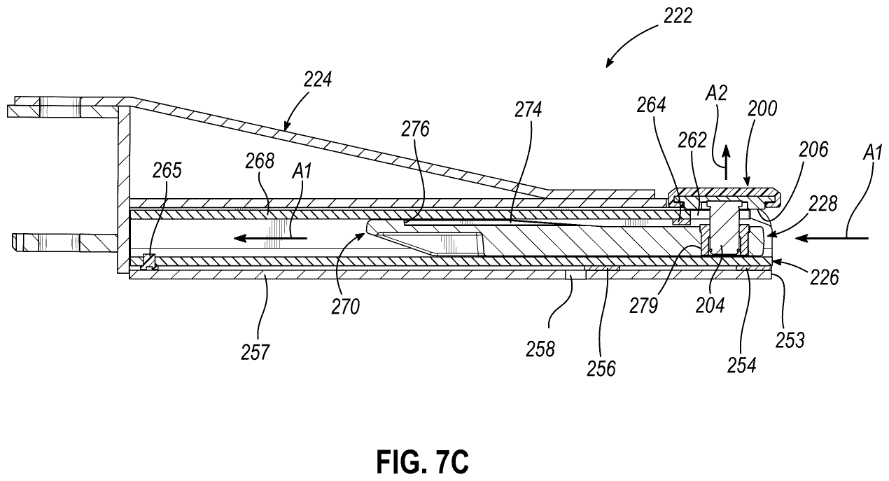

Groove (274) may be a channel or slit within a portion of adapter coupling arm (270) such that the groove (274) forms a valley within the top of adapter coupling arm (270). Due to the tapered nature of tapered body (272), the depth of groove (274) increases from its distal end associated with tapered body (272) toward its proximal end associated with groove end (276) and proximal top surface (284). Groove (274) may include a bottom surface that is substantially parallel with a bottom surface of adapter coupling arm (270). Alternatively, groove (274) may include a bottom surface that is sloped upward toward the top surface (284) in the proximal direction relative to a bottom surface of adapter coupling arm (270) such that the portion of bottom surface located adjacent to groove end (276) is vertically higher compared to the portion of bottom surface located adjacent to distal top surface (286). Such a sloped bottom surface of groove (274) may be used to slow extension as coupling arm (270) approaches a distal-most position via engagement between the bottom surface of groove (274) and groove stop (264) (see FIGS. 5A-5B and 7A). Additionally, or alternatively, the side walls of groove (274) may include sloped surfaces such that groove (274) is narrower nearer the proximal end than nearer its distal end. Such sloped side walls may be used to slow extension as coupling arm (270) approaches a distal-most position via engagement between the side surfaces of groove (274) and groove stop (264) (see FIGS. 5A-5B and 7A). As mentioned above, groove (274) terminates longitudinally into groove end (276). As will be described in greater detail later, groove end (276) forms a shoulder surface that engages a groove stop (264) (see FIGS. 5A-5B and 7A) of adjustable body (226) to prevent overextension of adapter coupling arm (270) relative to adjustable body (226).

Turning to FIG. 3B, proximal portion (280) of adapter coupling arm (270) defines a cutout (278). Cutout (278) is positioned along a bottom surface of adapter coupling arm (270) to thus form a “U” shaped channel in adapter coupling arm (270). Cutout (278) extends from an opposing end of adapter coupling end (228) towards adapter coupling end (228). Cutout (278) may follow an external side contour of adapter coupling arm (270) such that there is sufficient lateral sidewall to support adapter coupling arm (270) to inhibit an undesirable amount of lateral and/or vertical flex. Portions of adapter coupling arm (270) defining cutout (278) are structurally robust to suitably support a vehicle during exemplary use in accordance with the description herein. In some instances, cutout (278) may be positioned beneath groove (274) such that an opening is formed between groove (274) and cutout (278). Alternatively, as shown in the current example, material may remain between cutout (278) and groove (275) to thereby keep them as separate cavities. Cutout (278) may have any suitable geometry as would be apparent to one skilled in the art in view of the teachings herein.

Cutout (278) may reduce the overall weight of adapter coupling arm (270) without substantially reducing the load strength. The reduction of the overall weight of adapter coupling arm (270) may provide easier telescoping movement of adapter coupling arm (270) relative to the adjustable body (226). Bottom surfaces of adapter coupling arm (270) that are lateral to cutout (278) may remain along the same plane as the remaining bottom surface (288) of adapter coupling arm (270). As shown, adapter coupling arm (270) may include angled edges (290) extending into cutout (278). Adapter coupling arm (270) may be produced through a forging or a mold casting process.

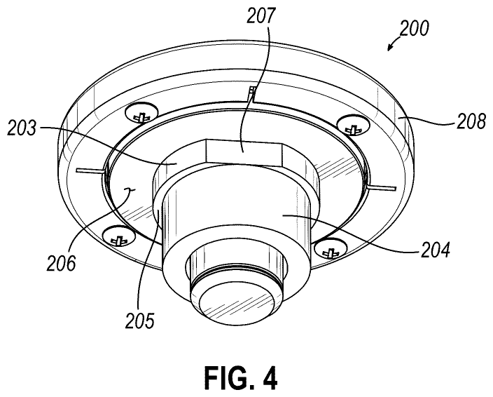

FIG. 3C shows adapter coupling end (228) having a key recess (277) and opening (279) dimensioned to receive select portions of adapter (200). Adapter coupling end (228) includes a recessed upwardly presented surface (276) that partially defines key recess (277). Key recess (277) is configured to accept adapter collar (203) of adapter (200) and also inhibit rotation of adapter collar (203) when inserted into opening (279). Key recess (277) includes one or more keys such that key recess (277) is capable of locking adapter collar (203) in more than one rotational position via engagement between keys and engagement surfaces (207) (see FIG. 4) of adapter collar (203). Upwardly presented surface (276) is configured to engage a downwardly presented shoulder (205) of adapter (200) in order to transmit the load of a supported vehicle from adapter (200) onto adapter coupling arm (270) in a low-profile configuration. Opening (279) may be in the form of a through-hole or a blind-hole and can be configured to axially align adapter collar (203) with adapter coupling end (228). Opening (279) may also be in a shape other than a circle such that adapter collar (203) is rotationally restricted once inserted into opening (279). Additionally, adapter (200) may be vertically adjustable by way of a suitable vertical adjustment mechanism that would be obvious to one of ordinary skill in the art in view of the teachings herein. For example, a suitable screw mechanism may be used to readily adjust the vertical position of adapter (200) relative to adapter coupling end (228). Other non-limiting examples of such a vertical adjustment mechanism include a stepped adjustment, a cam adjustment, a plurality of replaceable adapters with varying heights, a vertically telescoping adapter, etc.

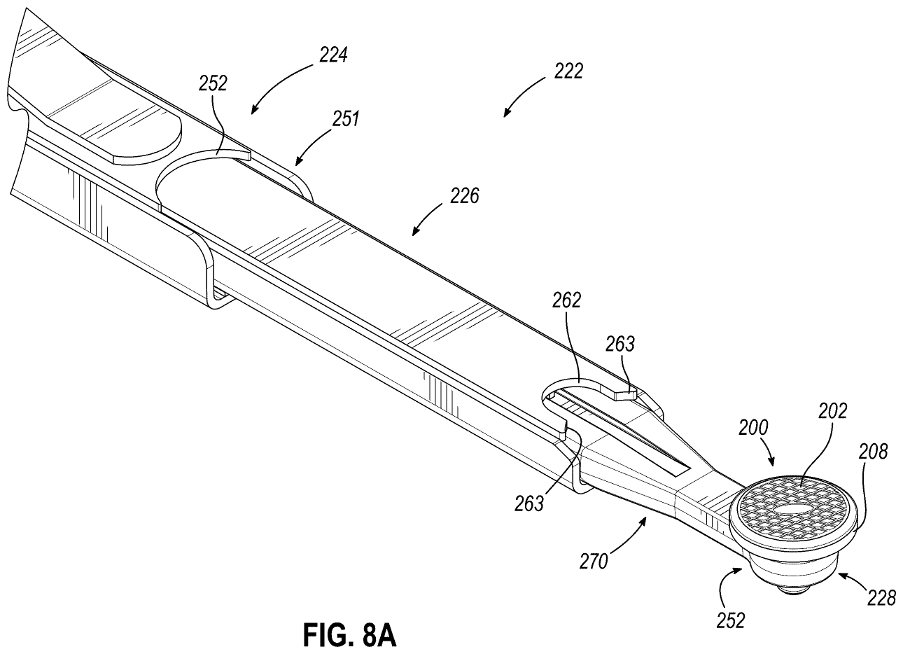

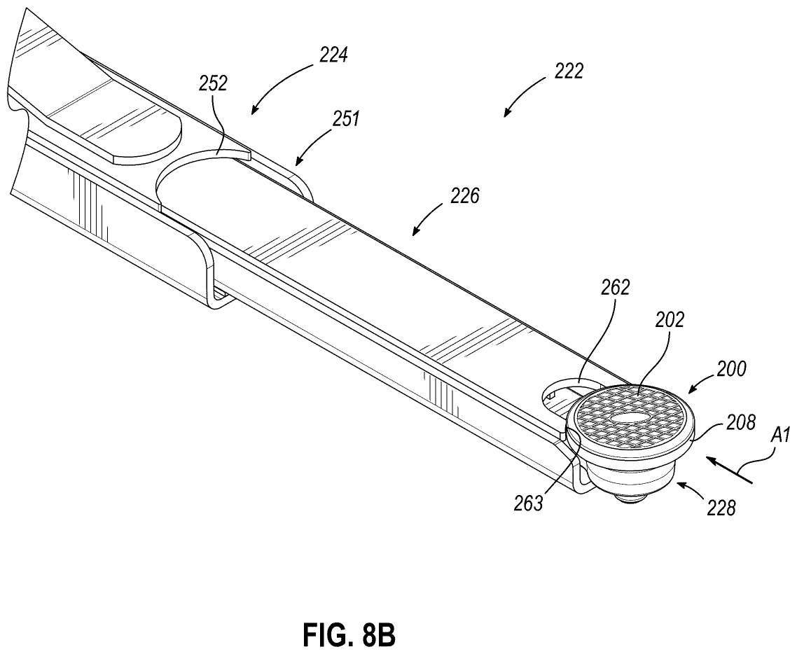

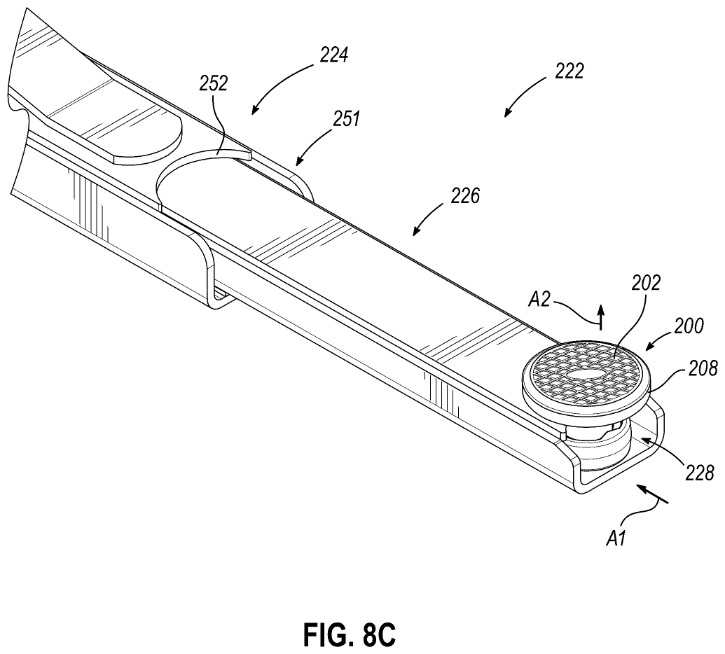

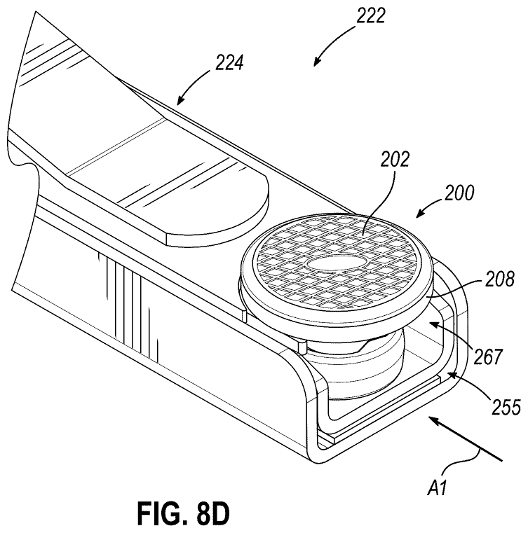

FIG. 4 shows a bottom side perspective view of adapter (200) having the adapter collar (203), a shaft (204), a support surface (206), and a contact pad (208). Adapter collar (203) protrudes downward from support surface (206) and is shaped and sized to fit within key recess (277) to rotationally inhibit adapter collar (203) and adapter (200) via engagement between engagement surfaces (207) and keys of key recess (277). Adapter collar (203) includes downwardly presented shoulder (205) which is configured to engage upwardly presented surface (276) of adapter coupling end (228) in a low-profile configuration, to thereby transfer the load of a supported vehicle from adapter (200) onto adapter coupling arm (270). As will be described in greater detail herein, while adapter (200) is in the low-profile configuration relative to adapter coupling arm (270), suitable portions of contact pad (208) (e.g., an outer perimeter of contact pad (208)) are configured to be directly adjacent to (e.g., come into contact with) pad engagement surfaces (263) of second notch (262) of adjustable body (226) (see FIG. 8B). As will also be described in greater detail herein, adapter collar (203) is dimensioned to fit adjacent to second notch (262) of adjustable body (226) while adapter (200) is in a raised configuration relative to adapter coupling arm (270) and adapter coupling arm (270) is completely housed within telescoping channel (267) of adjustable body (226) (see FIG. 8C).

Turning back to FIG. 4, shaft (204) extends downward beyond support surface (206) and adapter collar (203) to act as a guide for adapter (200) when adapter (200) is inserted into opening (279) of adapter coupling end (228). Shaft (204) may be circular in shape or may be non-circular such that it may inhibit rotation of adapter (200) when inside opening (279). Shaft (204) may be either longer or shorter than opening (279) is deep and may include a rounded tip to aid in the positioning of shaft (204) within opening (279).

Support surface (206) extends radially beyond adapter collar (203) and shaft (204). As mentioned above, in the low-profile configuration, downwardly presented shoulder (205) of adapter (200) and upwardly present surface (276) of adapter coupling end (228) are engaged with each other in order to transmit the load of a lifted vehicle from adapter (200) onto adapter coupling arm (270). Adapter collar (203), shaft (204), and support surface (206) may be formed of a metal such as steel, or any suitable material as would be apparent to one skilled in the art in view of the teachings herein.

Contact pad (208) is positioned on top of support surface (206). Contact pad (208) includes a contact surface (202) configured to engage one or more lifting points of a vehicle. Contact pad (208) may be made using rubber or plastic and may be the point of contact between the vehicle and the remaining portions of adjustable lifting arm (222). Contact pad (208) may be modular and different contact pads (208) may come in differing shapes and sizes depending on the application.

FIG. 5A shows a perspective view of adjustable body (226). Adjustable body (226) may be in the form of a hollow channel or tube defining telescoping channel (267) and includes second notch (262) located at distal portion (261). Second notch (262) may include a channel or opening on an upper portion (268) of adjustable body (226) and may be semicircular in shape. As will be described in greater detail below, second notch (262) is sized and shaped to accommodate adapter (200) when adapter coupling arm (270) is retracted within adjustable body (226). Additionally, second notch (262) includes pad engagement surfaces (263) configured to engage pad (208) in the retracted, low-profile configuration (see FIG. 8B).

Support surface (206) of adapter (200) may include a larger diameter than second notch (262) such that support surface (206) rests on top of second notch (262) when adapter coupling arm (270) is in the retracted configuration (see FIG. 8C). As shown between FIGS. 8B-8C, should adapter (200) be lifted from adapter coupling arm (270) to rest on top of adjustable body (226), shaft (204) may still be long enough to engage opening (279) for continued alignment.

FIG. 5B shows a front perspective view of adjustable body (226). Adjustable body (226) includes a groove stop (264), also referred to as an abutment, positioned within adjustable body (226). Groove stop (264) is a protrusion from an upper portion (268) of adjustable body (226) and projects downwards into a telescoping channel (267) of adjustable body (226). Groove stop (264) is dimensioned to slidably fit within groove (274) of adapter coupling arm (270) and may have a profile matching that of groove (274). Groove stop (264) is configured to contact groove end (276) of groove (274) when adapter coupling arm (270) is extended away from adjustable body (226) in a fully extended configuration. In this manner, groove end (276) contacting groove stop (264) may thereby define a fully extended configuration of adapter coupling arm (270) relative to adjustable body (226). Groove stop (264) contacts groove end (276) such that further extension of adapter coupling arm (270) relative to adjustable body (226) may be inhibited or prevented. In other words, groove stop (264) and groove (274) interact with each other to prevent overextension of adapter coupling arm (270) relative to adjustable body (226). It should be understood that since groove stop (264) is housed within telescoping channel (267), this may reduce the overall vertical profile of adjustable body (226) and lifting arm (222) as compared to groove stop (264) being located on an exterior surface of adjustable body (226). Therefore, the location of groove stop (264) within telescoping channel (267) may allow adapter (200) to be lowered closer to floor (16) during exemplary use as compared to being on an exterior surface of adjustable body (226).

Groove stop (264) may be formed, welded, or screwed into the upper portion (268) of adjustable body (226). Groove stop (264) may be selectively removed from adjustable body (226) to thus allow adapter coupling arm (270) to be removed from adjustable body (226) and can be positioned such that groove stop (264) does not project beyond the outside of adjustable body (226) and contact collar (224). Groove stop (264) may alternatively be securely fixed such that adapter coupling arm (270) is inserted into adjustable body (226) through an open end (266) opposite second notch (262).

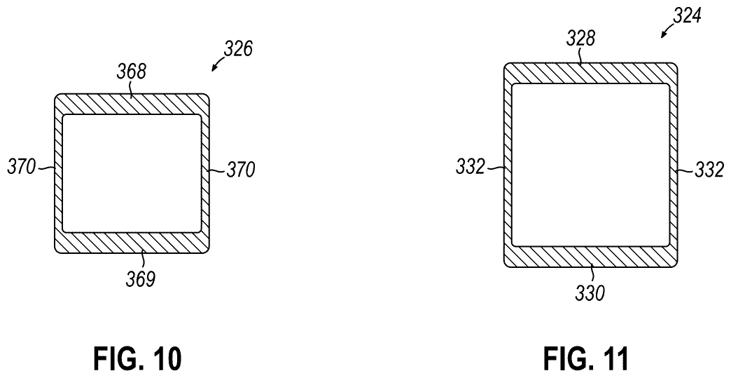

Upper portion (268) of adjustable body (226) may be welded to the remaining portions of adjustable body (226). Adjustable body (226) may also be largely extruded as a single piece and groove stop (264) may be added after. FIG. 10 shows an alternative adjustable body (326) formed from an extrusion process. Therefore, adjustable body (336) is substantially similar to adjustable body (226) described above, with differences elaborated herein. Upper portion (368) and opposing lower portion (369) may be thicker than the lateral sidewalls (370) of adjustable body (326). Therefore, lateral sidewalls (370) may be thinner than the lateral sidewalls of adjustable body (226). Making lateral sidewalls (370) thinner than upper and lower portions (368, 369) may reduce the weight of adjustable body (326), which may provide easier telescoping movement of adjustable body (326). Additionally, making lateral sidewalls (370) thinner than upper and lower portions (368, 369) may reduce the amount of material needed to form adjustable body (326) compared to adjustable body (226) described herein.

Turning back to FIG. 5B, adjustable body (226) includes a stop contact (265) on lower portion (269). Stop contact (265) may extend outside of lower portion (269) and in a downward direction. Stop contact (265) may be selectively coupled to lower portion (269). As a non-limiting example, stop contact (265) may include a screw which is threaded into an opening in lower portion (269) where a head of the screw projects downward from lower portion (269). Stop contact (265) may or may not extend into the channel of adjustable body (226).

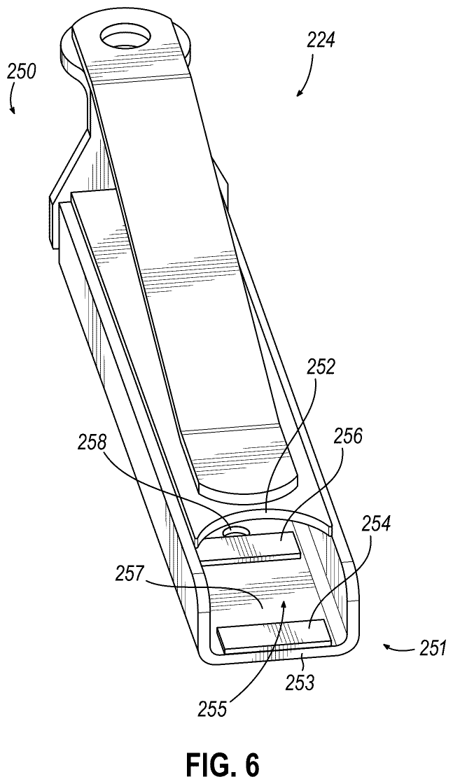

FIG. 6 shows a perspective view of collar (224) having a support surface (254), a stop (256), and an opening (258). Support surface (254) is positioned near edge (253) of collar (224) located at distal end (251) of collar (224). Support surface (254) is configured to vertically support a portion of adjustable body (226). Support surface (254) may be comprised of a low friction material and may also be suitable for applications of high wear. Support surface (254) supports adjustable body (226) such that adjustable body (226) does not contact lower portion (257) of collar (224). Therefore, support surface (254) may reduce the frictional braking force between engaging surface of collar (224) and adjustable body (226), which may also enable easier telescoping movement of adjustable body (326).

Similar to adjustable body (226), collar (224) may have a welded-on upper portion. Alternatively, collar (224) may be extruded largely as a single piece. FIG. 11 shows an alternative collar (324) formed from an extrusion process. Therefore, collar (324) is substantially similar to collar (224) described above, with differences elaborated herein. Upper portion (328) and opposing lower portion (330) may be thicker than the lateral sidewalls (332) of collar (324). Therefore, lateral sidewalls (332) may be thinner than the lateral sidewalls of collar (224). Making lateral sidewalls (322) thinner than upper and lower portions (328, 330) may reduce the weight of collar (324), which may improve the movability of collar (324). Additionally, making lateral sidewalls (332) thinner than upper and lower portions (328, 330) may reduce the amount of material needed to form collar (324) compared to collar (224) described herein.

Turning back to FIG. 6, stop (256) is positioned away from edge (253) relative to support surface (254) such that there is a distance between support surface (254) and stop (256). Stop (256) may be secured to lower portion (257) and inside of collar (224) and configured to contact stop contact (265) of adjustable body (226) when adjustable body is in an extended configuration relative to collar (224). Stop (256) may thereby define an extended configuration of adjustable body (226) as being when stop contact (265) contacts stop (256). Stop (256) may prevent adjustable body (226) from over-extending by interfering with stop contact (265). It should be understood that since stop (256) is housed within telescoping channel (255), this may reduce the overall vertical profile of collar (224) and lifting arm (222) as compared to stop (256) being located on an exterior surface of collar (224). Therefore, the location of stop (256) within telescoping channel (255) may allow adapter (200) to be lowered closer to floor (16) during exemplary use as compared to being on an exterior surface of collar (224). In other words, positioning stop (256) inside of collar (224) may decrease the overall vertical profile of adjustable lifting arm (222) to thereby decrease a distance between contact surface (202) of adapter (200) and floor.

The distances between lower portion (257) and upper portion of collar (224) are such that adjustable body (226) may slide within collar (224) until stop (256) contacts stop contact (265). Stop (256) and/or support surface (254) may contain felt wipers that store lubricant to reduce wear and promote smooth movement between collar (224) and adjustable body (226). Stop (256) and or support surface (254) may include a bearing or a set of bearings that promote smooth movement between collar (224) and adjustable body (226).

While in the current example stop (256) and support surface (254) are two different pieces spaced apart from each other, stop (256) and support surface (254) may have any suitable spatial relationship as would be apparent to one skilled in the art in view of the teachings herein. For example, stop (256) and support surface (254) may be a single piece of material. As another example, stop (256) and support surface (254) may abut against each other in an end-to-end fashion.

As mentioned above, collar (224) defines stop contact opening (258). During assembly of adjustable body (226) into collar (224), adjustable body (226) may be inserted into collar (224) to where stop contact opening (258) axially aligns with an attachment point for stop contact (265). At such a point, stop contact (265) may be passed through stop contact opening (258) and attached to adjustable body (226). Stop contact opening (258) may be positioned further from edge (253) than stop (256).

FIGS. 7A-8D show a method of using the adjustable lifting arm (222) and transitioning between a fully extended configuration (FIGS. 7A and 8A), a partially retracted configuration (FIGS. 7B and 8B-8C), and a fully retracted configuration (FIGS. 7C and 8D). FIG. 7A shows adjustable lifting arm (222) in the fully extended configuration with adjustable body (226) extended relative to collar (224) and adapter coupling arm (270) extended relative to adjustable body (226). When fully extended, stop contact (265) may be in contact with stop (256), groove end (276) may be in contact with groove stop (264), and support surface (206) may be in contact with a top surface of adapter coupling arm (270). Engagement between stop contact (265) and stop (256) prevents adjustable body (226) from being over-extended relative to collar from the fully extended position shown in FIG. 7A. Additionally, contact between groove end (276) and groove stop (264) prevents adapter coupling arm (270) from being overextended relative to adjustable body (226) from the fully extended position shown in FIG. 7A. Additionally, adapter (200) sits in the low-profile configuration (highlighted in FIG. 9) such that lifting arm (222) may suitably access and engage the underside of lower profile vehicles, such as EVs.

As shown between FIGS. 7A-7B and 8A-8B, a user my actuate adapter coupling arm (270) within telescoping channel (267) of adjustable body (226) until pad (208) abuts against pad engagement surfaces (263) and such that groove stop (264) is no longer engaged with groove end (276). Therefore, adapter (200) may maintain the low-profile configuration while adapter coupling arm (270) is between any location shown between FIGS. 7A-7B and 8A-8B. It should be understood that a user may further customize the overall length of lifting arm (222) by also telescoping adjustable body (226) within collar (224), thereby allowing adapter (200) to reach various lengths while still maintaining the low-profile configuration.

As shown between FIGS. 8B-8C, if a user desires to further retract adapter coupling arm (270) within telescoping channel (267) of adjustable body (226), the user may move adapter (200) upwards within adapter coupling end (228) and retract adapter coupling arm (270) such that pad (208) no longer abuts against surfaces (263) and such that contact pad (208) rests above second notch (262).

When retracting adjustable lifting arm into the fully retracted configuration shown in FIGS. 7C and 8D, a retracting force may be applied to adapter coupling arm (270), adapter (200), and/or adjustable body (226) towards collar (224). When sliding adjustable body (226) towards collar (224), adjustable body (226) may be partially supported by support surface (254), and stop contact (265) may cease contact with stop (256). Once adjustable body (226) is fully retracted into collar (224), edge (253) of collar (224) may be flush with or extend beyond a similar outside edge of adjustable body (226). Additionally, as shown in FIG. 8D, the entirety of pad (208) is located proximally to edge (253). Notch (252) also houses and/or engages a portion of the periphery of pad (208) in the fully retracted position. Therefore, lifting arm (222) allows adjustable body (226), adapter coupling arm (270), and adapter (200) to be located proximally to edge (253) in the fully retracted position. This nesting configuration allows vehicle engagement pad (208) to be located proximally to edge (253) of collar (224) when adjustable body (226) is in the fully retracted position, which may allow adjustable lifting arm (222) to access a wider range of vehicle lifting points compared to lifting arms with vehicle engagement pads that are located distally relative to collar (224) when adjustable body (226) is in that position. Additionally, adapter (200) is configured to suitably engage a vehicle in the fully retracted position.

In the fully retracted position, edge (253) of collar (224) is located distally beyond the furthest edge of adapter coupling arm (270) such that adapter coupling arm (270) is fully inside adjustable body (226) and collar (224). In some instances, second notch (262) may rotationally orient or inhibit adapter (200) once adapter (200) is placed within second notch (262) as shown in FIG. 8C. When fully retracted, first notch (252) of collar (224) may be sized and shaped such that contact pad (208) of adapter (200) may fit within first notch (252) without interference.

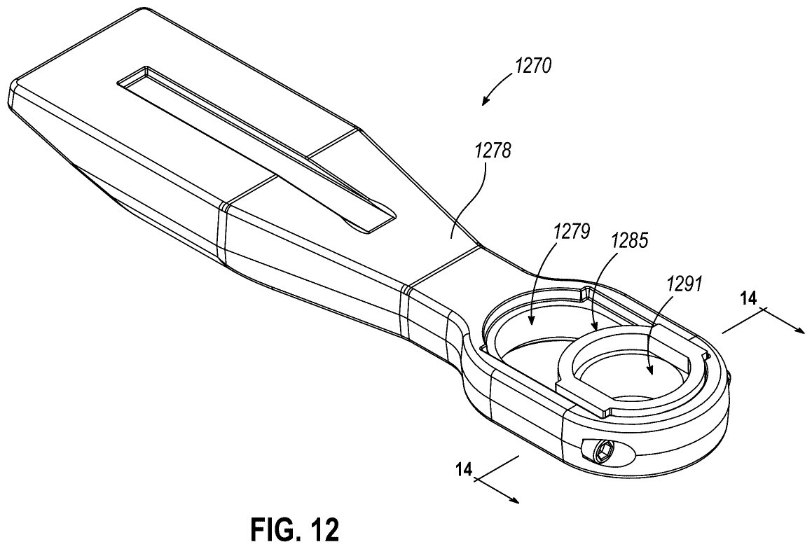

FIG. 12 illustrates a top perspective view of an alternative adapter coupling arm (1270). Adapter coupling arm (1270) may be substantially similar and may function substantially similarly to adapter coupling arm (270) except for the following differences. Therefore, it should be understood that adapter coupling arm (1270) may be readily incorporated into adjustable lifting arm (222) in replacement of adapter coupling arm (270). Adapter coupling arm (1270) includes an adapter coupling arm body (1278) and a sleeve (1285) slidably coupled to adapter coupling arm body (1278). Adapter coupling arm body (1278) defines an elongate opening (1279) capturing sleeve (1285) slidable therein.

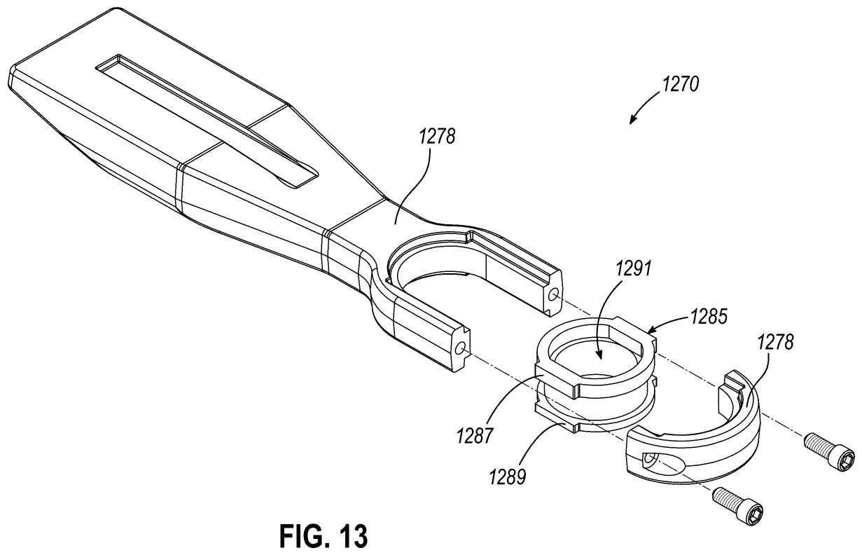

FIG. 13 illustrates a top perspective exploded view of adapter coupling arm (1270) with sleeve (1285) including an upper flange (1287), a lower flange (1289), and an opening (1291). Upper and lower flanges (1287, 1289) vertically contain sleeve (1285) within elongate opening (1279) while allowing sleeve (1285) to slide along a path defined by elongate opening (1279). Opening (1291) of sleeve (1285) is sized to fit adapter collar (203) and shaft (204) of adapter (200) such that adapter (200) is supported by adapter coupling arm (1270) while still being able to slide with sleeve (1285). In other words, adapter (200) may selectively couple with sleeve (1285) via opening (1291) such that sleeve (1285) and adapter (200) are configured to actuate relative to adapter coupling arm body (1278) along the path defined by elongate opening (1279).

In some instances, adapter coupling arm body (1278) may be a unitary component. In other instances, as shown in FIG. 13, adapter coupling arm body (1278) may be assembled from multiple components in order to slidably capture sleeve (1285), or it may be assembled as shown. Adapter (200) and adapter coupling arm (1270) may be capable of achieving any of the configurations shown in FIGS. 7A-8D. It should be understood that, in some instances, adapter coupling arm (1270) and adapter (200) may be fully retracted within adjustable body (226) regardless of the position of sleeve (1285) within elongate opening (1279).

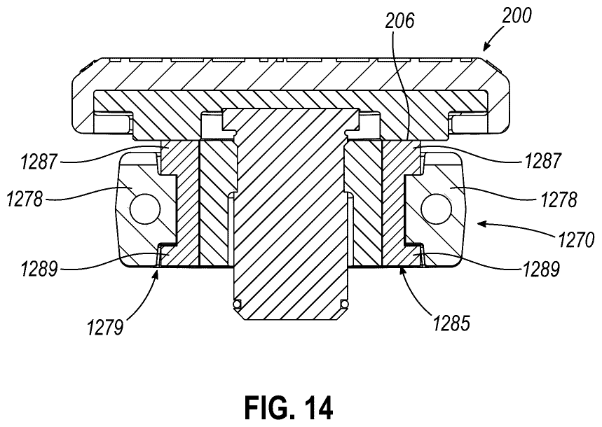

FIG. 14 illustrates a cross-sectional view of adapter coupling arm (1270) taken along line 14-14 and with adapter (200) included. As shown, upper and lower flanges (1287, 1289) vertically capture sleeve (1285) within elongate opening (1279). Support surface (206) of adapter (200) may also contact a top surface of sleeve (1285) to vertically support adapter (200).

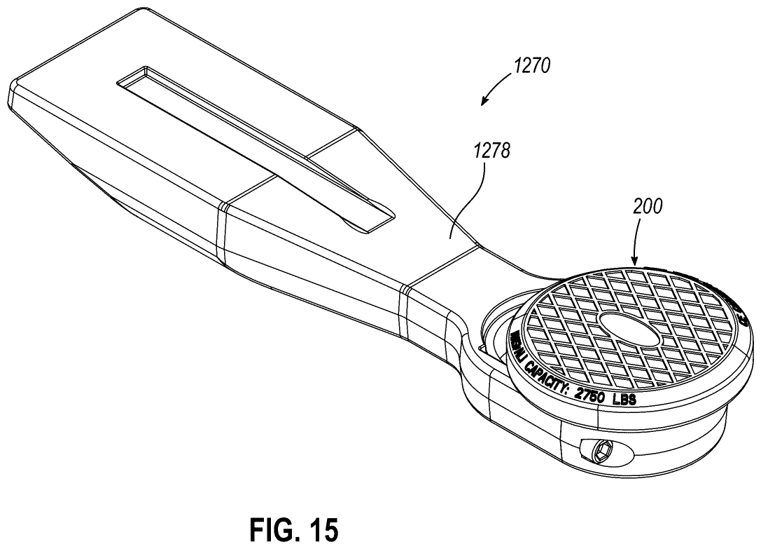

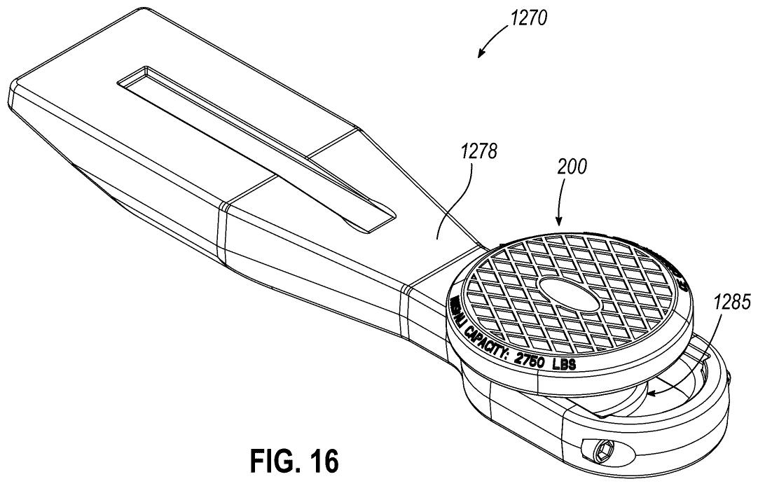

FIGS. 15-16 illustrate sliding adapter (200) from a distal position, as shown in FIG. 15, to a proximal position, as shown in FIG. 16, within elongate opening (1279). An operator may slide adapter (200) and sleeve (1285) together by applying either a distal or proximal force on adapter (200). Adapter (200) and adapter coupling arm (127) are capable of lifting a vehicle while the adapter (200) is in the proximal or distal position of elongate opening (1279), or any other position therebetween. Therefore, it should be understood that an operator may use adapter coupling arm (1270) to make minor adjustments to the position of adapter (200) relative to adapter coupling arm body (1278). Sliding adapter (200) relative to adapter coupling arm (1270) therefore defines adjustable lifting arm (22) as a four-stage arm where four components are independently translatable relative to each other.

### III. Illustrative Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A vehicle engagement assembly attached to a vehicle lift, wherein the vehicle lift is configured to actuate the engagement assembly between a lowered position and a raised position, the vehicle engagement assembly comprises: (a) a first arm comprising a first notch and having a distalmost edge, (b) a second arm configured to transition between a first extended configuration and a first retracted configuration relative to the first arm, (c) an adapter coupling arm comprising a coupling portion, wherein the adapter coupling arm is configured to translate within the second arm between a second extended configuration and a second retracted configuration, and (d) an adapter configured to couple with the coupling portion, wherein the adapter is configured to fit adjacent to the first notch such that the adapter is proximal to the distalmost edge when both the second arm is in the first retracted configuration and the adapter coupling arm is in the second retracted configuration.

### Example 2

The vehicle engagement assembly of the preceding Example, wherein the adapter is configured to fit within a second notch of the second arm when the adapter coupling arm is in the second retracted configuration.

### Example 3

The vehicle engagement assembly of any one or more of the preceding Examples, wherein the adapter includes a vehicle contact surface, wherein the vehicle contact surface is configured to be positioned above the first notch when the adapter is coupled with the coupling portion, the second arm is in the first retracted configuration, and the adapter coupling arm is in the second retracted configuration.

### Example 4

The vehicle engagement assembly of any one or more of the preceding Examples, wherein the adapter is configured to nest within each of the first notch and a second notch of the second arm.

### Example 5

The vehicle engagement assembly of any one or more of the preceding Examples, wherein the coupling portion is configured to limit rotation of the adapter.

### Example 6

The vehicle engagement assembly of any one or more of the preceding Examples, wherein the adapter includes a first cross-section sized to fit within the first notch and a second cross-section sized to fit with a second notch of the second arm.

### Example 7

The vehicle engagement assembly of any one or more of the preceding Examples, wherein the adapter is configured to be positioned at a first height when the adapter coupling arm is in the second retracted position and at a second height when the adapter coupling arm is in the second extended position, wherein the first height is higher than the second height.

### Example 8

The vehicle engagement assembly of any one or more of the preceding Examples, wherein the adapter coupling arm includes a groove having a groove end, wherein the second arm includes an abutment, wherein the abutment is configured to traverse the groove and contact the groove end to thereby prevent the adapter coupling arm from extending beyond the second extended configuration.

### Example 9

The vehicle engagement assembly of any one or more of the preceding Examples, wherein the adapter coupling arm includes a taper extending towards the coupling portion.

### Example 10

The vehicle engagement assembly of any one or more of the preceding Examples, wherein the adapter coupling arm includes a lower cutout such that a portion of the adapter coupling arm is a U channel.

### Example 11

The vehicle engagement assembly of any one or more of the preceding Examples, wherein the first arm includes a support and a channel having a lower portion, wherein the second arm is positioned within the channel, wherein the support is positioned on the lower portion and is configured to contact the second arm to thereby lift the second arm away from the lower portion.

### Example 12

The vehicle engagement assembly of any one or more of the preceding Examples, wherein the first arm includes a stop, wherein the stop is configured to contact the second arm when the second arm is in the first extended configuration.

### Example 13

The vehicle engagement assembly of Example 12, the second arm including a stop contact, wherein the stop contact is configured to contact the stop when in the first extended configuration to thereby prevent the second arm from extending beyond the first extended configuration.

### Example 14

The vehicle engagement assembly of Example 13, the first arm including an opening configured to allow the stop contact to pass through the opening and to attach to the second arm while the second arm is in a channel of the first arm.

### Example 15

The vehicle engagement assembly of any one or more of the preceding Examples, wherein the second arm includes upper, lower, and lateral sidewalls, wherein the upper and lower sidewalls are thicker than the lateral sidewalls.

### Example 16

A vehicle engagement assembly attached to a vehicle lift, wherein the vehicle lift is configured to actuate the engagement assembly between a lowered position and a raised position, the vehicle engagement assembly comprises: (a) a first arm defining a channel and a stop, the stop being positioned within the channel, the channel including an opening, (b) a second arm including a stop contact, wherein the second arm is configured to transition between a first extended configuration and a first retracted configuration about the first arm, wherein the stop contact is configured to traverse through the opening to thereby selectively couple with the second arm and, once coupled with the second arm, to contact the stop to thereby define the first extended configuration and to prevent the second arm from extending beyond the first extended configuration, (c) an adapter coupling arm comprising a coupling portion and configured to transition between a second extended configuration and a second retracted configuration relative to the second arm, and (d) an adapter configured to couple with the coupling portion and to contact a vehicle.

### Example 17

The vehicle engagement assembly of Example 16, wherein the second arm includes a notch, wherein the adapter is configured to fit within the notch when the adapter coupling arm is in the second retracted configuration.

### Example 18

The vehicle engagement assembly of any one or more of the preceding Examples, wherein the first arm further includes a support, wherein the second arm is positioned within the channel, wherein the support is positioned on the lower surface and is configured to contact the second arm to thereby lift the second arm away from the lower surface, wherein the support and the stop are separated by a distance.

### Example 19

A method of using a vehicle engagement assembly attached to a vehicle lift, wherein the vehicle engagement assembly comprises: a first arm comprising a first notch, a second arm comprising a second notch, and an adapter coupling arm comprising an adapter, wherein the second arm is translatable relative to the first arm, and the adapter coupling arm is translatable relative to the second arm, the method comprising translating the second arm relative to the first arm, translating the adapter coupling arm relative to the second arm, and nesting the adapter into the first notch and the second notch.

### Example 20

The method of Example 19, further comprising extending the adapter coupling arm about the second arm to thereby unnest the adapter from the second notch, and, once unnested, lowering the adapter onto the adapter coupling arm.

I/We claim:

1. A vehicle engagement assembly attached to a vehicle lift, wherein the vehicle lift is configured to actuate the engagement assembly between a lowered position and a raised position, the vehicle engagement assembly comprises:
(a) a first arm comprising a first notch and having a distalmost edge,
(b) a second arm configured to transition between a first extended configuration and a first retracted configuration relative to the first arm,
(c) an adapter coupling arm comprising a coupling portion, wherein the adapter coupling arm is configured to translate within the second arm between a second extended configuration and a second retracted configuration, and
(d) an adapter configured to couple with the coupling portion, wherein the adapter is configured to fit adjacent to the first notch such that the adapter is proximal to the distalmost edge when both the second arm is in the first retracted configuration and the adapter coupling arm is in the second retracted configuration.

2. The vehicle engagement assembly of claim 1, wherein the adapter is configured to fit within a second notch of the second arm when the adapter coupling arm is in the second retracted configuration.

3. The vehicle engagement assembly of claim 1, wherein the adapter includes a vehicle contact surface, wherein the vehicle contact surface is configured to be positioned above the first notch when the adapter is coupled with the coupling portion and when the vehicle engagement assembly is in the first and second retracted configuration.

4. The vehicle engagement assembly of claim 1, wherein the adapter is configured to nest within each of the first notch and a second notch of the second arm.

5. The vehicle engagement assembly of claim 1, wherein the coupling portion is configured to limit rotation of the adapter.

6. The vehicle engagement assembly of claim 1, wherein the adapter includes a first cross-section sized to fit within the first notch and a second cross-section sized to fit with a second notch of the second arm.

7. The vehicle engagement assembly of claim 1, wherein the adapter is configured to be positioned at a first height when the adapter coupling arm is in the second retracted position and at a second height when the adapter coupling arm is in the second extended position, wherein the first height is higher than the second height.

8. The vehicle engagement assembly of claim 1, wherein the adapter coupling arm includes a groove having a groove end, wherein the second arm includes an abutment configured to traverse the groove and contact the groove end to thereby prevent the adapter coupling arm from extending beyond the second extended configuration.

9. The vehicle engagement assembly of claim 1, wherein the adapter coupling arm includes a taper extending toward the coupling portion.

10. The vehicle engagement assembly of claim 1, wherein the adapter coupling arm includes a lower cutout such that a portion of the adapter coupling arm is a U channel.

11. The vehicle engagement assembly of claim 1, wherein the first arm includes a support and a channel having a lower portion, wherein the second arm is positioned within the channel, wherein the support is positioned on the lower portion and is configured to contact the second arm to thereby lift the second arm away from the lower portion.

12. The vehicle engagement assembly of claim 1, wherein the first arm includes a stop, wherein the stop is configured to contact the second arm when the second arm is in the first extended configuration.

13. The vehicle engagement assembly of claim 12, the second arm including a stop contact, wherein the stop contact is configured to contact the stop when in the first extended configuration to thereby prevent the second arm from extending beyond the first extended configuration.

14. The vehicle engagement assembly of claim 13, the first arm including an opening configured to allow the stop contact to pass through the opening and to attach to the second arm while the second arm is in a channel of the first arm.

15. The vehicle engagement assembly of claim 1, wherein the second arm includes upper, lower, and lateral sidewalls, wherein the upper and lower sidewalls are thicker than the lateral sidewalls.

16. A vehicle engagement assembly attached to a vehicle lift, wherein the vehicle lift is configured to actuate the engagement assembly between a lowered position and a raised position, the vehicle engagement assembly comprising:
(a) a first arm defining a channel and a stop, the stop being positioned within the channel, and the channel including an opening,
(b) a second arm including a stop contact, wherein the second arm is configured to transition between a first extended configuration and a first retracted configuration relative to the first arm, wherein the stop contact is configured to traverse through the opening to thereby selectively couple with the second arm and, once coupled with the second arm, to contact the stop to thereby define the first extended configuration and to prevent the second arm from extending beyond the first extended configuration,
(c) an adapter coupling arm comprising a coupling portion and configured to transition between a second extended configuration and a second retracted configuration relative to the second arm, and
(d) an adapter configured to couple with the coupling portion and to contact a vehicle.

17. The vehicle engagement assembly of claim 16, wherein the second arm includes a notch, wherein the adapter is configured to fit within the notch when the adapter coupling arm is in the second retracted configuration.

18. The vehicle engagement assembly of claim 16, wherein the first arm further includes a support, wherein the second arm is positioned within the channel, wherein the support is positioned on the lower surface and is configured to contact the second arm to thereby lift the second arm away from the lower surface, wherein the support and the stop are separated by a distance.

19. A method of using a vehicle engagement assembly attached to a vehicle lift, wherein the vehicle engagement assembly comprises a first arm comprising a first notch, a second arm comprising a second notch, and an adapter coupling arm comprising an adapter, wherein the second arm is translatable relative to the first arm, and the adapter coupling arm is translatable relative to the second arm, the method comprising:
(i) translating the second arm relative to the first arm;
(ii) translating the adapter coupling arm relative to the second arm; and
(iii) nesting the adapter into the first notch and the second notch.

20. The method of claim 19, further comprising extending the adapter coupling arm relative to the second arm to thereby unnest the adapter from the second notch, and, once unnested, lowering the adapter onto the adapter coupling arm.
